(19) United States
(12) Patent Application Publication
(10) Pub. No.: US 2016/0069786 A1
(43) Pub. Date: Mar. 10, 2016

(54) AN OPTICAL SYSTEM AND A METHOD FOR REAL-TIME ANALYSIS OF A LIQUID SAMPLE

(71) Applicant: KONINKLIJKE PHILIPS N.V., EINDHOVEN (NL)

(72) Inventors: TOMMY WINTHER BERG, Kopenhagen (DK); ERIK SPILLUM, Frederiksberg (DK); MARTIN CHRISTIAN VALVIK, Hillerod (DK); TOM OLESEN, GORLOSE (DK)

(21) Appl. No.: 14/785,199

(22) PCT Filed: Apr. 15, 2014
(86) PCT No.: PCT/DK2014/050099

§ 371 Date: Oct. 16, 2015

(30) Foreign Application Priority Data
Apr. 19, 2013 (DK) PA 2013 70222

(51) Int. Cl. G01N 15/02; G01N 15/06

(52) U.S. Cl. CPC G01N 15/0211; G01N 15/0227; G01N 15/06; G01N 2015/0693

(57) ABSTRACT

An optical system suitable for determining a characteristic as a function of time of at least a part of a liquid volume comprising a plurality of objects. The optical system provides a fast detection of a change in the liquid volume. The optical system comprises—an optical detection assembly comprising at least one image acquisition device configured to acquire images of an image acquisition area; —a sample device comprising at least one sample container suitable for holding a sample of said liquid volume; —a translating arrangement configured to translate said image acquisition area through at least one part of said sample container to perform a scan along a scanning path through said part of said sample container; and—an image analyzing processing system. The optical system is programmed to perform consecutive scans through said at least one part of said sample container, wherein each scan comprises acquiring images at a plurality of image acquiring positions of the image acquisition area by the optical detection assembly along at least one scanning path of the scan. The image analyzing processing system is programmed to determine a set of features in the form of a set of values for each of a plurality of objects captured on said images from each respective scan and to determine for each scan at least one derived result, the derived result is derived from a plurality of the sets of values, and to present said derived result obtained from the respective, consecutive scans as a function of time.

### TECHNICAL FIELD

The present invention relates to an optical system and a method for performing a real-time analysis of a liquid sample comprising determining a characteristic as a function of time of the liquid sample comprising a plurality of objects.

### BACKGROUND ART

Real-time analysis of liquid samples is used within many technical areas where it is desired to determine a change of objects in the sample. Such real-time analyses are often quit time consuming if a high precision result is needed. Real-time analysis is in particular used for determining susceptibility of the objects in a sample to one or more selected substances e.g. antibiotic susceptibility in liquid samples which are for example applied to determine the types of micro organisms present in a sample or to determine if a microorganism in the sample is susceptible to selected antibiotics to thereby find antibiotics for treatment of a patient infected by the microorganism.

Antibiotic susceptibility testing is used in hospitals, health clinics, medical production plants, food and drink production plants etc. The large number of different chemicals and standardized procedures and the enormous number of tests performed each year give room for a huge industry benefitting from the microorganisms growing everywhere. Many of the prior art tests are very time consuming e.g. due to long test incubation periods, require excessive manpower e.g. for isolating and growing the microorganism in Petri dishes or similar and/or are very expensive.

Because the prior art susceptibility tests often take a long time, physicians tend to prescribe broad band antibiotics to infected patients irrespectively of the fact that most often a more narrow band antibiotics targeted directly at the cause of the disease could have been used. Even where a susceptibility test is performed and a narrow band antibiotics targeted directly at the cause is found, it is common standard to continue treatment with the broad band antibiotics, since stopping an antibiotic treatment before completion has found to be one of the leading causes of antibiotic resistance.

Since the use of broad band antibiotics increases the risk of creating multi-resistant pathogen microorganisms, compared to the risk when using narrow band antibiotics, there is a need for performing susceptibility tests as fast as possible.

One of the most common susceptibility tests performed is testing urine for urinary tract infections (UTI). Such susceptibility tests are often performed at a central laboratory which may increase the test result delivery time further.

When the best antibiotic for destroying the microorganisms has been determined, it is often important to determine the antibiotic concentration to be prescribed (minimum inhibitory concentration (MIC)). This test can add further delay before the optimal treatment can be prescribed.

Present test methods require the use of a large number of different chemicals and standardized procedures. The standards in US are maintained by CLSI (Clinical and Laboratory Standards Institute). The standards describe test details such as how to set up tests, including inoculation (concentrations), isolation distances, temperatures, inspection of growth results, incubation periods. Tests incubation periods may vary from a few hours (e.g. 16-24 hours) to several days (e.g. 3-6 days).

Several attempts for providing improved real-time analysis have been made in particular with the purpose of reducing test time, to use automated test procedures or to reduce cost.

US 2008/0268469 discloses a particulate analyzer which allows one or more marked particulates to be measured in a flowing condition in both forward and reverse flow directions. A streamline of particulates (a “plug”) can be formed within a volume of a fluid by, e.g., oscillating the fluid back-and-forth within a capillary; the plug can be controlled so as to oscillate through a measurement area for analysis.

U.S. Pat. No. 6,153,400 discloses a method and an apparatus for performing microbial antibiotic susceptibility testing including disposable, multi-chambered susceptibility plates and an automated plate handler and image acquisition and processing instrument. The susceptibility plates are inoculated with a microorganism and anti-microbial agent(s) are applied such that the microorganism is exposed to a variety of concentrations or a gradient of each anti-microbial agent. The plates are then placed in the instrument, which monitors and measures the growth of the microorganisms. This data is used to determine the susceptibility of the microorganism to the antibiotics. Such a system automates antimicrobial susceptibility testing using solid media and Kirby-Bauer standardized result reporting. The system is partly automatic, but handles agar disks for diffusion tests.

U.S. Pat. No. 4,448,534 discloses an apparatus for automatically scanning electronically each well of a multi-well tray containing many liquid samples. A light source, preferably a single source, is passed through the wells to an array of photosensitive cells, one for each well. There is also a calibrating or comparison cell receiving the light. Electronic apparatus reads each cell in sequence, quickly completing the scan without physical movement of any parts. The resultant signals are compared with the signal from the comparison cell and with other signals or stored data and determinations are made and displayed or printed out. Thereby such matters as minimum inhibitory concentrations (MIC) of drugs and identification of microorganisms may be achieved.

US 2012/0244519 discloses a system and a method for performing microbial susceptibility testing where the system is capable of determining a value for at least one parameter describing microbial activity of individual biological organisms in a liquid sample. The system comprises a scanning equipment for acquiring images to form at least a first optical sectioning of biological organisms in the liquid sample, and for analyzing the images to determine the value describing microbial activity of the individual biological organisms in the sample. The system may be applied to several samples simultaneously. The scanning and value determination may be repeated for a sufficient period until sufficient information is acquired.

The above described susceptibility test systems and methods have shown to be effective in many situations, however, there is still a need for improvements in particular with respect to performing very fast and reliable real-time analysis.

### DISCLOSURE OF INVENTION

An object of the present invention is to provide an optical system and a method for performing a real-time analysis of a liquid sample comprising a plurality of objects where the analysis can be performed fast while still providing highly reliable results.

A further object is to provide an optical system and a method which can be applied for performing a susceptibility test which is both fast and provides highly reliable results.

These and other objects have been solved by the invention as defined in the claims and as described herein below.

It has been found that the invention and/or embodiments thereof have a number of additional advantages which will be clear to the skilled person from the following description.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

The term “substantially” should herein be taken to mean that ordinary product variances and tolerances are comprised.

The optical system of the invention is suitable for determining one or more characteristics as a function of time of at least a part of a liquid volume comprising a plurality of objects.

The term “characteristic” used about the liquid volume or a part thereof is herein used to mean any property or combination of properties that can be optically determined or that can be derived there from. Examples of suitable characteristics are provided below. Advantageously the characteristic applied is a characteristic that relates to a certain property of the objects in the liquid volume, such as a state or growth where the objects are microorganism or a state of corrosion where the objects are metal.

In the following description the term “characteristic” when used in singular should be interpreted to also include the plural meaning of the term unless it is clear from the text that it means a single characteristic.

The term “object” means any matter in the liquid volume that is not dissolved in the liquid and can be optically detected, e.g. by a light scattering optical system or a light absorption optical system. Advantageously the objects are particles or clusters of particles. Examples of particles are described below. In an embodiment the objects are gas bubbles.

In the following description the term “object” when used in singular should be interpreted to also include the plural meaning of the term unless it is clear from the text that it means a single object.

The optical system of the invention comprises
an optical detection assembly comprising at least one image acquisition device configured to acquire images of an image acquisition area;
a sample device comprising at least one sample container suitable for holding a sample of the liquid volume;
a translating arrangement configured to translate the image acquisition area through at least one part of the sample container to perform a scan along a scanning path through the part of the sample container; and
an image analyzing processing system.

The optical system is programmed to perform consecutive scans through the at least one part of the sample container, wherein each scan comprises acquiring images of said image acquisition area by the optical detection assembly at a plurality of positions of the image acquisition area as it is translated along at least one scanning path of the scan.

Generally it is desired that one image is acquires at each of the plurality of positions. These positions are in the following also referred to as ‘image acquiring positions’ of the image acquisition area.

The image analyzing processing system is programmed to determine a set of features in the form of a set of values for each of a plurality of objects captured on the images from each respective scan and determine for each scan at least one derived result. The derived result is derived from a plurality of the sets of values and presents the derived result obtained from the respective, consecutive scans as a function of time.

The scanning path can have any desired length. The scanning path is defined by the programming of the translation unit and the position between the sample device and the optical detection assembly. The term “consecutive scans” means a plurality of scans performed directly after each other or with a selected time interval or intervals. The consecutive scans can be equal or they can differ from each other.

The term “a feature” means herein a property of an object of the liquid volume. A feature is directed to an object and not to the whole liquid volume or the part on which the determination is performed. A set of features means a number of features for the same object. The set of features are determined in the form of the set of values which make it possible to operate and perform the processing of data even where the features are of quite dissimilar types.

Whereas the set of features are determined for respective objects, the derived result is determined for each scan derived from a plurality of the sets of values. This means that the derived result is not a measure of individual objects but rather a measure of all of the objects used in the determination simultaneously.

The optical system of the invention has shown to be very fast and reliable, and it has been found that determinations of changes of objects in liquid volumes can be identified and analyzed surprisingly fast and with a very high reliability. It is believed that the reason for this advanced effect is due to the fact that the optical system performs determinations on respective objects while the derived result is a measure of all of the objects used in the determination. Where a feature of an individual object e.g. is subjected to a change with a long time interval (e.g. 1 hour), the derived result comprising the feature in question for a plurality of such objects will statistically much faster reflect a change of the objects. Simultaneously, undesired noise can be much reduced since the optical system performs the optical measurement on the individual objects.

The objects for which sets of values are determined can be of similar type or they can be different. In an embodiment the objects for which sets of values are determined are of the same material or of the same biological family. The acquired images at the respective image acquiring positions comprise images of a plurality of objects, preferably a plurality of objects for each scan.

The objects imaged in the respective scan can be equal or they can differ from each other.

In an embodiment the derived result is derived from a plurality of the sets of values with a preselected amplification.

In an embodiment the derived result is derived with a preselected amplification where the amplification is selected to amplify the derived result relative to an expected change where the expected change is the change that is adapted to be monitored for—e.g. a change of growth rate or wear.

In an embodiment where the expected change can be indicated by variance of a feature the derived result is derived with a preselected amplification comprising that the deriver result comprises the variance of the values for at least one feature of the respective sets of features.

In an embodiment the derived result is derived with a preselected amplification comprising that the deriver result comprises the variance of the values for at least one feature of the respective sets of features as well as the average and/or median of the values for the same at least one feature of the respective sets of features.

In an embodiment the derived result is derived with a preselected amplification in form of a preselected bias.

The derived result is derived with the preselected bias meaning that the values for at least one feature of the respective sets of features are applied with the preselected bias in the determination of the derived result

The phrase“a value for at least one feature of the respective sets of features” means each value for the feature in question for each of the objects. The preselected bias can be any bias providing that the values for the one or more features of the respective sets of features are not applied with equal weight. The preselected bias can for example be that a fraction of the lowest value for a feature is weighted lower than a fraction of the highest value for this feature. In an embodiment the preselected bias comprises ignoring values above or below a certain threshold. In an embodiment the preselected bias comprises basing values from sub-sets of values from the sets of values.

Advantageously the bias is selected to amplifying derived results which are indicating expected change(s) of the characteristic, where the expected change is the change(s) is the change that is adapted to be tested for—e.g. a change of growth rate or wear.

By obtaining the derived result from the plurality of the sets of values with a preselected bias a change of the characteristic will be observed even faster than where the sets of values are applied with equal weight, since even minor change of a few of the objects will be visible where the derived results are obtained with the preselected bias.

Advantageously a plurality of objects imaged in one of the consecutive scan is also imaged in a plurality of the other consecutive scan. Thereby a very fast determination of any changes of the characteristic in question can be found. Advantageously and for a high resolution the objects imaged in the respective scan are substantially identical meaning that about at least 90% of the objects imaged in one scan are also imaged in other scans, preferably all of the other scans of the consecutive scans.

In an embodiment the liquid sample constitutes the entire liquid volume to be examined. However, in most situations it is sufficient to perform the determination on a part of the liquid volume.

In an embodiment the sample represents a larger volume of liquid where the change in the sample is expected to be as in the larger volume of liquid.

In an embodiment the liquid sample is a volume part of the whole liquid volume. Where the liquid volume is substantially homogeneous it may be sufficient to determine the characteristic on a sample part of the whole liquid volume

In principle the volume of the liquid sample relative to the volume of the whole liquid can have any value such as from 0.0001% and up to 100% depending on the size of the volume of the whole liquid. In an embodiment the liquid sample is a specific withdrawn sample of the liquid volume optionally diluted for increased resolution. The volume of the liquid sample can for example be a few micro liters or even less, such as from 0.1 μl to 1 ml.

In an embodiment the liquid sample is a step wise or continuously changing part of the liquid volume. In this embodiment the sample device advantageously comprises at least one opening for feeding and/or withdrawing the liquid sample to and from the sample device, optionally this opening or openings comprise(s) a valve for adjusting and/or controlling the flow through the opening(s). The sample device may further comprise a pump for adjusting and/or controlling the flow through the opening(s). The sample container may e.g. be as described in WO 2011/107102. The description concerning the shape and operation of the sample device described in WO 2011/107102 is hereby incorporated by reference.

Due to the simplicity of the system it has been found that the optical system can be provided in a very compact and cost effective manner which makes it suitable for performing point of care susceptibility tests relatively fast while still providing highly reliably results.

The derived result obtained from the respective, consecutive scans as a function of time can be presented in any suitable way e.g. on a screen or on a paper. Often a computer is used for the presentation. The presentation can be in the form of a curve or in the form of a list of numbers.

The image analyzing processing system is preferably programmed to compare the derived results with a reference, such as a given set point or a curve or similar. The reference is for example an indication of an expected result if a sample is positive for a certain microorganism, antibiotic reaction or other which is relevant for the test. In an embodiment the derived result obtained from the respective, consecutive scans as a function of time can be presented in the form of its relation to a reference.

The term “as a function of time” is used to indicate that the derived results are timely displaced with an offset time as discussed below.

In an embodiment the object is a particle or a cluster of particles. The particles can be of biologic origin of or of non-biologic origin or they can be a mixture. In an embodiment the particles are selected from non-biologic particles, such as particles of metal, particles of polymer, crystals and mixtures thereof. In an embodiment the particles are selected from biologic particles, such as particles of bacteria, archaea, yeast, fungi, pollen, viruses, leukocytes, such as granulocytes, monocytes, Erythrocytes, Thrombocytes, oocytes, sperm, zygote, stem cells, somatic cells, malignant cells, drops of fat and mixtures thereof.

As it should be clear to the skilled person the particles can in principle be any kind of particles, however, it is in general preferred that the particles are particles which relatively fast can undergo changes e.g. when subjected to a selected condition.

A cluster of particles (also for simplification referred to as a cluster) means herein a group of particles which physically are more interrelated to each other than particles from another cluster of particles or particles that are not part of a cluster of particles. A cluster of particles will typically consist of particles which are significantly closer to other particles of the cluster of particles than particles from another cluster of particles or particles that are not part of a cluster of particles. The term “significantly closer” means herein at least about 10% closer. Advantageously the clusters of particles are determined to include particles with a distance to another closest particle of the cluster which is about 10% or less than a minimum distance from a particle of the cluster to the nearest particle which is excluded from the cluster of particles. In most situations it is immediately evident which particles form part of a cluster. Often the particles of a cluster of particles are in physically contact with each other.

In an embodiment a cluster of particles comprises particles of several types of particles. Such multi type particle cluster can be treated as being one object or alternatively the type particle cluster is subdivided into sub-clusters of respective types of particles. Advantageously an object based on a multi type particle cluster is in the form of such a sub-cluster comprising a selected type of particles. In this embodiment one or more remaining sub-cluster(s) can form separate objects and/or one or more remaining sub-cluster(s) can be disregarded as noise.

In an embodiment the cluster of particles is a cluster of particles of the same type and the liquid volume optionally comprises other particles which are treated as noise.

In an embodiment the particles comprise pathogens, such as pathogens selected from viral pathogens, bacterial pathogens, parasites, fungan pathogens, prionic pathogens and combinations thereof. It has been found that the optical system of the invention is highly effective for performing susceptibility tests for such pathogens.

The pathogen(s) can be any kind of pathogen or combination of pathogens which can be in a liquid sample. Examples of pathogens are the pathogens listed by National Institute of Allergy and Infectious Diseases (NIAID) of the United States.

The pathogens can for example be a food contaminating pathogen such as Bacillus cereus, Campylobacter jejuni, Clostridium botulinum, Clostridium perfringens, Cryptosporidium parvum, Escherichia coli 0157:H7, Giardia lamblia, Hepatitis A, Listeria monocytogenes, Norwalk, Norwalk-like, or norovirus, Salmonellosis, Staphylococcus, Shigella, Toxoplasma gondii, Vibrio, Yersiniosis.

The present invention is in particular advantageous where the object is or comprises a pathogen which causes disease in humans or animals.

The derived result is related to the characteristic to be determined such that the derived result determined as a function of time, i.e. determined with selected time interval or time intervals, provides information about the characteristic. The derived result can comprise information about several characteristics, if desired. The derived result can be in the form of a value or several values for the characteristics in question or it can be in the form of a symbol, such as an on/off sign, a yes/no sign, a true/false sign or a similar binary sign.

In an embodiment of the optical system the characteristic(s) comprises one or more of a geometric characteristic, such as size or shape; a light interaction characteristic, such as contrast, light scattering properties, absorption, transparency, number of particles in a cluster, distance between particles in a cluster, distance between clusters, formation or re-formation of particles or clusters of particles or homogeneity/inhomogeneity of the sample.

The characteristic which is to be determined as a function of time can in principle be any characteristic which could change over time. The characteristic is advantageously selected dependent on the sample to be tested and in light of what the sample is supposed to be tested for. If for example the sample is tested for presence of a microorganism which changes shape over time, the characteristic advantageously comprises a geometric characteristic, whereas where the sample is tested for decay of particles which decay affects its light interaction, the characteristic advantageously comprises a light interaction characteristic.

In an embodiment the characteristic is a multi feature determination which provides a fingerprint for a specific condition of the liquid sample and the particles in the liquid sample. When the characteristic is changing, the fingerprint is changing and thereby it can be concluded that the condition of the liquid sample and the particles is changing as well.

The fingerprint can e.g. be a fingerprint of a momentary condition or it can be a fingerprint of a developing condition.

In an embodiment the characteristic is a characteristic, which will undergo change if the particle or particles of the respective objects are subject to wear, decay growth, or death.

In an embodiment where the sample comprises particles of a material which are to be tested for wear (such as corrosion or swelling) e.g. under chemical and/or mechanical influence, which the sample can be subjected to between or during the scans, the characteristic(s) is advantageously selected to comprise one or more geometric characteristics and/or one or more light interaction characteristics.

In an embodiment where the sample initially does not comprise any particles but where particles are expected to be formed e.g. by crystallization, the characteristic(s) is advantageously selected to comprise one or more geometric characteristics and/or one or more light interaction characteristics. Until the first few particles are formed the derived result will normally be 0 or a symbol for 0. Thereafter the growth of the particles can be followed by the derived result as a function of time.

In an embodiment where the sample is suspected of comprising microorganisms which during growth form biofilms, the characteristic is selected to comprise formation or re-formation of particles or clusters of particles. Thereby when the derived result obtained from the respective scans is presented in the order of the scan it can be observed if one or more biofilms have or are about to be formed. Advantageously the derived result also comprises information relating to the position of such biofilms which can provide additional information about the organism in the sample.

In an embodiment the characteristic is a characteristic, which will undergo change if the particle or particles of the respective objects are or comprise living particles.

In an embodiment the characteristic provides a fingerprint showing if the objects are or comprise living particles. Advantageously the characteristic provides a fingerprint showing the growth condition, such as growth rate, nutrition consumption, nutrition state, death rate or other growth conditions

The liquid volume can be any type of liquid volume, where the liquid sample is at least partly liquid at the time of performing the scans.

The optical system can be any kind of optical system comprising an optical detection assembly, a sample device and a translating arrangement and an image analyzing processing system programmed as defined in the claims. In an embodiment the optical system is as described in US 2011/0261164, US 2012/0327404, US 2012/0244519 or in co-pending application DK PA 2012 70800 with the modification that the optical system is programmed to perform consecutive scans through a part of the sample container, wherein each scan comprises acquiring images at the image acquiring positions of the image acquisition area by the optical detection assembly along at least one scanning path of the scan; and the image analyzing processing system is programmed to determine a set of features in the form of a set of values for each of a plurality of objects captured on the images from the respective scans and determine for each scan at least one derived result, the derived result is derived from a plurality of the sets of values, and presenting the derived result obtained from the respective, consecutive scans as a function of time.

The optical system advantageously comprises an illumination device arranged to illuminate the sample preferably along an optical axis such that the electromagnetic waves are directed towards the sample device and the image acquisition device. The illumination device can be—or it can comprise—any type of light source emitting any kind of electromagnetic waves—visible or non-visible. The light source can be a laser light e.g. a supercontinum light source, ordinary light or any other light source which is suitable for the test to be performed.

The illumination device can be connected to or incorporated in the optical detection assembly or it can be a separate illumination device. The optical system can comprise several illumination devices. The illumination device is in an embodiment mounted to the optical detection assembly in a stationary connection.

The illumination device and the optical detection assembly is in an embodiment arranged to maintain the image as reflecting images i.e. the illumination device and the optical detection assembly are arranged on the same side of the sample device.

The optical system is programmed to perform consecutive scans through at least one part of the sample container comprising the sample, such that all or a part of the sample is scanned a plurality of times. In principle the plurality of consecutive scans can be scans of different parts of the sample, in particular where the sample is relatively homogeneous. Advantageously the plurality of consecutive scans comprises several scans of a first part of the sample. In an embodiment the optical system is programmed to perform several scans of a first part of the sample and several scans of a second part of the sample, thereby providing basis for observing if the sample is inhomogeneous or if it develops in an inhomogeneous way. In an embodiment the sample is changed partly or fully—continuously or step wise—in between determinations.

Preferably the optical system is configured to acquire said images of said image acquisition area at said plurality of positions, wherein said image acquisition area is at a standstill relative to the sample container.

The phrase “wherein said image acquisition area is at a standstill relative to the sample container” means that the image acquisition area is translated in steps and is at standstill i.e. between translation steps at the time of acquiring an image.

According to the invention it has been found that where the said image acquisition area is at a standstill relative to the sample container at the positions where the respective images are acquired, the system of the invention is even more optimized for determinations of changes of objects in liquid volumes fast and with a very high reliability.

In an embodiment the sample container is constructed to hold a sample at a substantially standstill during a scan.

The phrase that a sample is substantially at standstill means that the liquid sample is not subjected to flow or turbulent movement. The particles in the sample may move e.g. due to Brownian noise and/or movements of individual living objects and/or movement caused by the translating arrangement.

The sample container is advantageously shaped to ensure as little movement of a liquid sample hold therein as possibly such that the sample is not subjected to flow or turbulence during the scan. In an embodiment the container is shaped with only one opening e.g. a cavity with or without a lid.

advantageously the optical system is configured to acquire said images of said image acquisition area at said plurality of positions, wherein a sample in the sample container at a substantially standstill.

By acquiring the images while the sample is at a substantially standstill ensures that the images acquires will be as sharp as possibly, thereby resulting in a very high resolution which makes marking of the objects superfluous.

In an embodiment the optical system is programmed to perform the consecutive scans with a time offset between the respective scans.

The time offset is determined as the time between the initiations of the respective scans.

Advantageously the time offset between two scans is at least about 0.1 second, such as from about 1 second to about 24 hours, such as from about 5 seconds to about 10 hours.

The consecutive scans are performed with time offsets between the consecutive scans. The time offsets can be equal or different from each other. The optimal time offset between consecutive scans depends in particular on the sample and the objects in the sample. In principle the time offset can be as short as the optical detection assembly permits. However, if several scans after each other have shown no change of the characteristic in question, it will often be appropriate to apply a longer time offset in the following scan until a change of the characteristic in question has been observed.

Advantageously the optical system is programmed to set the time offset between scans about to be performed depending on the derived result obtained from one or more previously performed scans, preferably such that the time offset between scans about to be performed is relatively long if the derived result from two or more previously performed scans are substantially identical and such that the time offset between scans about to be performed is relatively short if the derived result from two or more previously performed scans are different from each other.

The optical system is preferably programmed to apply a relatively low time offset in the beginning of the determination e.g. with the first few scans. If the derived result does not change the optical system is preferably programmed to increase the time offset until a change of the derived result is observed, where after the time offset is reduced to obtain a good resolution of the change of the derived result.

Each scan comprises acquiring images at plurality of image acquiring positions of the image acquisition area by the optical detection assembly along at least one scanning path of the scan. The number of images acquired for each scan can be any number providing a suitable resolution. In an embodiment the number of images acquired for each scan is at least about 5, such as up to several thousand. The optimal number of images acquired for each scan depends on the size and type of liquid and objects as well as the concentration of objects and the type of test to be performed. The skilled person will be able to select a number which is both sufficient and adequate for a given test.

The image analyzing processing system advantageously comprises a memory onto which the acquired images are stored. Advantageously also data regarding the position of the acquired images are stored such that data regarding the position of the acquired image and optionally sub-images can be retrieved to be stored. A sub-image means a section of an image. The size and other relevant data may for example be stored as Meta data in the sub-image.

The image analyzing processing system is advantageously programmed to analyze the acquired images e.g. by sectioning them into sub-images, which are analyzed further. The segmentation advantageously comprises a process of partitioning a digital image into multiple segments (sets of pixels, also known as super pixels). The goal of segmentation is to simplify and/or change the representation of an image into something that is more meaningful and easier to analyze. Image segmentation is typically used to locate particles and boundaries (lines, curves, etc.) in images. In an embodiment the image segmentation comprises the process of assigning a label to every pixel in an image such that pixels with the same label share certain visual characteristics.

Advantageously the acquired image is first scanned for bad regions such as regions with a poor light level, regions where an item outside the sample container may have obscured the image, regions with signs of flow during the image acquisition, etc. These regions are then discarded from the rest of the procedure. Subsequently a segmentation of the particles in the rest of the acquired image is performed.

The segmentation advantageously comprises identification of each segment in the image that may appear to be an image of a particle. Preferably each identified segment is copied from the rest of the image and this sub-image is advantageously applied to a number of filters, such as a shape-filter, a size-filter, a contrast-filter, intensity filter, etc.

When a sub-image is accepted to comprise an image of an object e.g. a particle (in or out of focus), it is accepted for further processing. When all possible particles in the original image have been identified and logged, the original image may be stored for later use.

In an embodiment the sub-image is accepted to comprise an image of a particle if the sub-image passes one or more filters and the sub-image is then candidate to comprise an image of a particle, and the sub-image is therefore logged and stored. The accepted sub-image may be subjected to further processing such as described in co-pending patent application DK PA 2012 70800. In an embodiment the accepted sub-images are further sorted in relation to shape, color, size, in or out of focus or other optically detectable properties and advantageously sub-images of the same object found of a plurality of sub-images of the same scan are stacked and finally the set of features for the respective objects is determined. The term “sub-image” is herein used to mean a section of an acquired image comprising an object in or out of focus. The term “stack of sub-images” is used to mean a number of sub-images of the same object obtained in the same scan.

In an embodiment the set of features determined for a scan of a specific object is obtained as described in co-pending patent application DK PA 2012 70800. The term “object” as used in DK PA 2012 70800 means accepted sub-images, whereas herein it has the meaning as defined above.

The scanning path for the respective scans can be equal or different from each other. For a simpler determination the scanning path for the respective scans is substantially equal i.e. the same path is passed in the same or opposite scanning direction. Advantageously the scanning path is a straight path or a circular path. In an embodiment the translating arrangement is configured to translate the image acquisition area through the sample in the sample container by moving the sample container. In an embodiment the sample container is moved along one or more straight paths. In an embodiment the sample container is moved by rotation. The sample container can comprise several sample container sections each for a separate sample. In an embodiment the sample container comprises a plurality of sample container sections arranged in a circular pattern surrounding a center and the translating arrangement is configured to translate the image acquisition area through samples in the sample container sections by rotating the sample contained with the center as center axis. The rotating motion can simultaneously be used for adding a substance to one or more of the samples by pre-arranging the substance in a channel leading in a direction from the center to the one or more samples. Upon rotation of the sample container with a selected rotation rate the substance will be forced by centrifugal forces into the one or more sample containers.

In an embodiment the image analyzing processing system is programmed to determine sets of values for a predetermined set of features comprising at least N features, wherein N is 1 or more, such as 2 or more, such as 3 or more, such as 4 or more, such as up to about 100.

The number N can be any integer. In most situations N will be selected to be from about 3 to about 100.

The determination of the sets of values may e.g. be determined as described in DK PA 2012 70800.

In an embodiment the feature and set of features is as described in DK PA 201270800.

The features may be any features which alone or in combination with other features can be used to determine the characteristic in question.

Many different features may be defined and implemented. Each of the many features may be determined e.g. calculated for every particles of a scan, but usually a limited number of features are selected to be the set of features. The features in the set of features should advantageously be selected to provide as much information regarding the characteristic in question.

By a few experiments the skilled person can be able to select suitable features and set of features for a given test.

In an embodiment the set of features comprises features based on a threshold sub-image in focus, such as:
spatial descriptors such as area, length of perimeter, area of enclosing circle etc. and/or
morphological descriptors such as convexity, eccentricity, shape factor etc. and/or
binary moments

In an embodiment the set of features comprises features based on a grayscale version of a sub-image in focus, such as
contrast, light scattering properties, absorption etc. and/or
various types of grayscale moments and/or
features extracted in the Fourier space of the focused grayscale image, and/or
granularity

In an embodiment the set of features comprises features based on a color version of a sub-image in focus, for example
pre-dominant color pattern and/or
hue.

In an embodiment the set of features comprises features based on information from a stack of sub-images of the same object in and out of focus, such as
signatures/descriptors of various focus curves of the sub-images, such as FWHM, AUC, variance between the curve and a smoothed curve etc. and/or
signatures/descriptors of various intensity curves of the sub-images, such as FWHM, AUC, variance between the curve and a smoothed curve etc. and/or
signatures/descriptors of curves generated by applying grayscale/binary features to individual sub-image in the stack of sub-images,
assessment of temporal parameters of the stack,
phase and absorption map, Brownian movement and self-propelled characteristic, and/or

In an embodiment the image analyzing processing system is programmed to determine values for a set of features comprising at least one of
features relating to out-of-focus sub-image of the stack of sub-images,
features relating to grayscale versions of in-focus sub-image,
features relating to color versions of in-focus objects,
features relating to thresholded versions of in-focus sub-image and/or
features relating to both in-focus and out-of-focus sub-image

In an embodiment the features relating to out-of-focus sub-image may comprise one of
circumference of the particle (shape),
size of particle (cross-sectional area),
ratio between the largest and the smallest diameter,
color variation (degree of color variation) and/or
pre-dominant color pattern.

In an embodiment the features relating to in-focus sub-image comprise at least one of
circumference of the particle (shape),
size of particle (cross-sectional area),
ratio between the largest and the smallest diameter,
color variation (degree of color variation),
predominant color pattern, and/or
number of sub-particles inside the circumference of the particle.

In an embodiment the features relating to both out-of-focus sub-image and in-focus sub-image comprise at least one of
difference(s) in circumference of the particle (shape) from one sub-image to another of a stack of sub-images,
difference(s) in size of particle (cross-sectional area) from one sub-image to another of a stack of sub-images,
difference(s) in ratio between the largest and the smallest diameter from one sub-image to another of a stack of sub-images,
difference(s) in color variation (degree of color variation) from one sub-image to another of a stack of sub-images,
difference(s) in predominant color pattern from one sub-image to another of a stack of sub-images,
difference(s) in color from one sub-image to another of a stack of sub-images, and/or
distance between respective objects.

The derived result is derived from the sets of values of the sets of features. At least two sets of values are used to obtain the derived result and advantageously for a high accuracy all of the sets of values of a scan are used to obtain the derived result. Other parameters, such a preset constants or amplifying parameters or algorithm can be used in obtaining the derived result for a scan.

The derived result is advantageously in the form of one value or of a plurality of values. The derived result is in an embodiment in the form of one or more frequencies, one or more binary signals which are similar or indicative for the characteristic in question as described above.

In an embodiment the derived result is in the form of a number N₂ of values, preferably the number N₂ of values is from 2 to the number N of values of the respective sets of values for the respective N features of the set of features.

In an embodiment N₂ is larger than N₁. In an embodiment N₂ is up to 5 values larger than N₁, the additional values can for example comprise a value for the number of objects for which a set of feature is determined.

In an embodiment the optical system is arranged such that the sample (i.e. the part of the liquid volume under examination) in the sample container can be subjected to an external exposure during the consecutive scans, the external exposure is for example, heat, cooling, irradiation, magnetic exposure, electrical exposure, pressure, centrifugal forces, vibrations or other mechanical forces such as forcing the sample through a constriction to generate a venture effect.

By subjecting the sample to an external exposure the test can for example be accelerated or elements in the sample container can be mixed.

In an embodiment the optical system is configured to determine a plurality of characteristics as a function of time of in the liquid sample.

Advantageously the optical system is configured to determine one or more characteristics as a function of time of a liquid sample comprising a plurality of first objects and a plurality of second objects. Thereby characteristics for two or more object types (namely first objects and second objects) can be determined simultaneously. Preferably the image analyzing processing system is programmed to determine a set of features in the form of a set of values for each of a plurality of first objects captured on the images from the respective scans, and a set of features in the form of a set of values for each of a plurality of second objects captured on the images from the respective scans and determine for each scan at least one derived result.

The first objects and the second objects are preferably of different types, e.g. different types of microorganism, where the image analyzing processing system is capable of distinguishing between the first objects and the second objects. In an embodiment the optical system is configured to determine one or more characteristics as a function of time of a liquid sample comprising a plurality of each of several types of objects, such as of 3 or more types of objects. The type of objects differs from each other in at least one optically detectable property.

In an embodiment the optical system is configured to determine one or more characteristics as a function of time of at least two samples simultaneously. Thereby several tests can be performed simultaneously e.g. for testing susceptibility. The system is preferably programmed to continue performing consecutive scans until the derived result for one of the samples differs significantly from the derived result for another one of the samples.

In an embodiment the optical system is configured to determine one or more characteristics as a function of time of from 2 to 200 samples simultaneously. A full susceptibility test for a given infection can by such optical system be performed very fast optionally within minutes. The system is preferably programmed to add at least one substance to one or more of the samples and/or to expose one or more of the samples to an external exposure prior to, during or between the consecutive scans.

The substances can for example be nutrient, agents (biocides, antibiotics etc.), diluting liquid, ph regulator, tensides and combinations thereof. In an embodiment the system is programmed to remove at least one substance from one or more of the samples. The removal can e.g. be performed by filtering liquid from the sample(s).

In an embodiment the optical system is adapted for determining and for adjusting a characteristic as a function of time of at least a part of the liquid volume comprising a plurality of objects. In this embodiment the optical system further comprises a feedback configuration arranged to subject the sample and/or the liquid volume to an influence in response to a determined characteristic.

The influence is advantageously an influence that modifies all of the liquid volume or merely the part of the liquid volume.

In an embodiment the influence comprises one or more external exposures, such as heat, cooling, irradiation, magnetic exposure, electrical exposure, pressure, centrifugal forces, vibrations or other mechanical forces. In an embodiment the influence comprises adding one or more substances, such as nutrient, agents (biocides, antibiotics etc.), diluting liquid, ph regulator or tensides. In an embodiment the influence comprises removing one or more substances, such as liquid via a filter. By this embodiment a reaction, a change or a lack of change can be followed and regulated/adjusted with almost no time delay.

In an embodiment the optical system is programmed to adjust the characteristic according to a pre-selected pattern, which pre-selected pattern can be a stationary pattern or a pattern that changes as a function of time.

The pattern can for example correspond to preferred parameters for the development of a fermentation process or another developing process in a liquid volume.

In an embodiment the pre-selected pattern is a single or a multi feature parameter range where each point in the pattern provides a fingerprint of a condition of the liquid and/or the objects in the liquid. The pattern can be selected to be very narrow such that in principle it represents one single finger print or it can be set to be larger to include a range of similar, but not identical fingerprints. A single fingerprint can for example be a fingerprint of a nutrient amount per object, whereas a range of similar fingerprints can be of a range of nutrient amounts per object.

In an embodiment the optical system is programmed to adjust the characteristic to be substantially constant.

In an embodiment the optical system is programmed to adjust the characteristic of the liquid sample only.

In an embodiment the optical system is programmed to adjust the characteristic of the whole liquid volume.

In an embodiment the optical system is programmed to adjust the characteristic of a water volume, the characteristic provides a fingerprint of the cleanliness of the liquid volume, and the optical system is programmed to keep the water volume sufficiently clean according to a pre-selected set point by adding as little substance to the water volume as possible. This embodiment can for example be applied in a pool or a drinking water system, where the amount of added chemicals such a chloride should be kept as low as possible.

The invention also relates to a method of determining a characteristic as a function of time of a liquid volume comprising a plurality of objects.

The method comprises performing consecutive scans through at least one part of a liquid sample of the liquid volume using at least one image acquisition device configured to acquire images of an image acquisition area, wherein each scan comprises translating the image acquisition area along at least one scanning path through the at least one part of the sample and acquiring images at the plurality of image acquiring positions of the image acquisition area, and

determining a set of features in the form of a set of values for each of a plurality of objects captured on the images from each respective scan and determining for each scan at least one derived result, the derived result is derived from a plurality of the sets of values, and presenting the derived result obtained from the consecutive scans as a function of time.

The method of the invention can advantageously be performed using the optical system described above. The method can further be performed with the various preferences as described above.

Advantageously the method comprises providing that said image acquisition area is at a standstill relative to the sample container when acquiring said respective images of said image acquisition area at said plurality of positions.

To ensure high resolution of the images it is desired that the image acquisition area is at a standstill relative to the sample container at each of the positions of the image acquisition area where an image is acquired. Thereby the determinations of changes of objects in liquid volumes becomes even more fast and with a very high reliability

In an embodiment method comprises holding the sample at a substantially standstill during the scan.

By holding the sample at a substantially at standstill during the scan adds further to improve resolution and thereby the speed and reliability to the determination. Whereas the liquid sample is not subjected to flow or turbulent movement it may be moved together with the sample container preferably is steps such that the respective images advantageously is acquires in between steps of the translating movement.

To ensure very high resolution it is desired that the method comprises holding the sample at a substantially standstill at the image acquiring positions of the image acquisition area during the acquisition of the respective images.

By acquiring the images while the sample is at a substantially standstill ensures that the images acquires will be as sharp as possibly, thereby adding further to a high resolution which makes marking of the objects superfluous.

In an embodiment the method comprises continuously performing the consecutive scans for a predetermined time, the time can be set in relation to the type of objects expected to be in the liquid volume. When performing wear test the number of times for scanning is usually a desired set point.

In an embodiment the method comprises continuing performing the consecutive scans until a pre-selected number of scans have been performed.

In an embodiment the method comprises continuously performing the consecutive scans until the characteristic has reached a selected change in the form of a selected difference between the derived results from a first scan to a last scan of the consecutive scans. Thereby the scans can be continued until for example a significant change has been observed e.g. until it is clear whether a certain antibiotic is effective or not.

In an embodiment the method comprises adding at least one substance to the sample prior to, during or between the performances of consecutive scans, the substance preferably being as described above.

In an embodiment the method comprises subjecting the sample to an external exposure during the consecutive scans, the external exposure is for example as described above.

In an embodiment the method comprises determining one or more characteristics as a function of time in at least two samples simultaneously, e.g. as described above. Preferably the method comprises continuously performing consecutive scans for a selected period e.g. as described above, until the derived result for one of the samples differs significantly from the derived result for another one of the samples.

In an embodiment the method comprises continuously performing consecutive scans from a first to a last scan until the derived result from the last scan differs significantly from the derived result from the first scan, preferably with a preselected maximum test time where the method is terminated, even if no difference between the derived result from the last scan and the derived result from the first scan is observed.

In an embodiment the method comprises determining one or more characteristics as a function of time of from 2 to 200 samples simultaneously, the method preferably comprises adding at least one substance, such as described above, to one or more of the samples and/or exposing one or more of the samples to an external exposure prior to, during or between the consecutive scans.

In an embodiment the method comprises determining and adjusting a characteristic as a function of time of at least a part of the liquid volume comprising a plurality of objects, the method comprises subjecting the sample and/or the liquid volume to an influence in response to a determined characteristic. The influence is advantageously a modification as described above poisonously applied as a feedback regulation.

All features of the inventions including ranges and preferred ranges can be combined in various ways within the scope of the invention, unless there are specific reasons not to combine such features.

### BRIEF DESCRIPTION OF DRAWINGS

The invention will be explained further below in connection with preferred embodiments and examples.

FIG. 1 shows a schematic perspective view of an optical system according to an embodiment of the present invention,

FIG. 2 shows a schematic perspective view of another optical system according to an embodiment of the present invention.

FIG. 3 shows a schematic sketch showing the elements of an optical system according to an embodiment of the present invention.

FIGS. 4a, 4b, 4c are images of respective image scans of a yeast sample as described in example 4

FIG. 4d is a growth curve of a yeast sample as described in example 4

FIGS. 5a, 5b, 5c are images of respective image scans of an acidophilus bacteria sample as described in example 5

FIG. 5d is a growth curve of an acidophilus bacteria sample as described in example 5

The figures are schematic and may be simplified for clarity. Throughout, the same reference numerals are used for identical or corresponding parts.

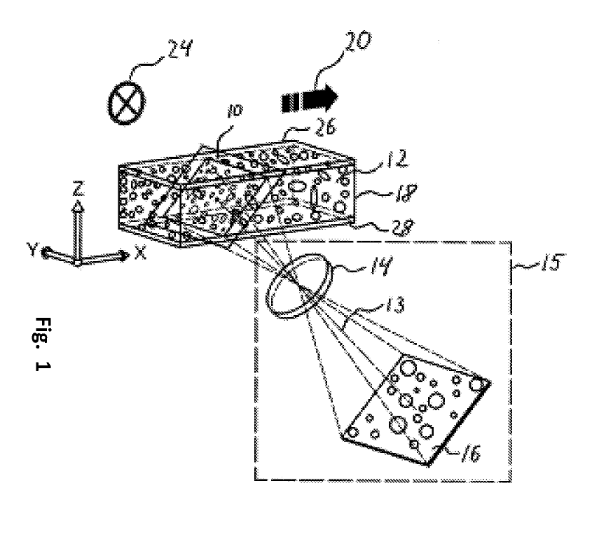

The optical system shown in FIG. 1 comprises an optical detection assembly 15 where only a few elements thereof are shown. The optical detection assembly 15 comprises an image acquisition device 16 and a lens 14 arranged to focus light towards the image acquisition device 16. The optical system further comprises an image illuminating device 24. The image illuminating device 24 comprises a not shown light source which can be any kind of light source. The optical system further comprises a sample container 18 suitable for holding a sample 12 of a liquid volume. The illuminating device 24 emits a suitable light beam directed towards the sample container 18. The sample container 18 is illustrated with a upper first confinement 26 and a lower second confinement 28, defining a height in Z direction of a coordinate system, where the X-direction of the coordinate system is aligned in a length direction of the sample container 18 and the Y-direction of the coordinate system is aligned in a width direction of the sample container 18. The first confinement 26 and the second confinement 28 are made of a material transparent to the electromagnetic waves from the illuminating device 24. Preferably also other confining walls of the sample container 18 are transparent to the electromagnetic waves from the illuminating device 24.

The optical system further comprises a not shown translation arrangement. The optical detection assembly 15 and the sample container 18 are arranged such that an image acquisition area 10 is generated at least partly within the sample 12 in the sample container 18. Preferably the illumination device is positioned in a fixed position relative to the optical detection assembly 15.

The optical system further comprises a not image analyzing processing system which is programmed to determine a set of features in the form of a set of values for each of a plurality of objects captured on the images from each respective scan and to determine for each scan at least one derived result as described above. The derived result obtained from the respective, consecutive scans is advantageously presented by being disposed on a screen of a not shown PC.

In use the illuminating device 24 emits light towards the sample 12 within the sample device 18. The light is transmitted through the sample 12 along an optical axis 13 and toward the lens 14 and image acquisition device 16 where an image of the image acquisition area 10 can be obtained. To obtain a scan the optical detection assembly 15 and the sample container 18 are translated by the not shown translation arrangement to move the image acquisition area 10 along a scanning path which can be a path in any of the X, Y or Z directions or a combination thereof. In the shown embodiment it is preferred that the scanning path is along the X-direction in the direction 20 or in the opposite direction. The scans may e.g. alternately be in the direction 20 or in the opposite direction. As the acquisition area 10 is moved along the scanning path a plurality of images are acquired by the image acquisition device 16. Advantageously the translation is in the form of step wise translations where the image acquisition device 16 acquires an image for each step. The step size can advantageously be selected for a given sample.

The image acquisition area 10 may e.g. extend beyond the sample device 18, or at least extend beyond the first confinement 26 and the second confinement 28 of the sample device 18. The acquired images can thereby comprise an image of the two confinements, and this information may be used to determine the height of the image acquisition area 10.

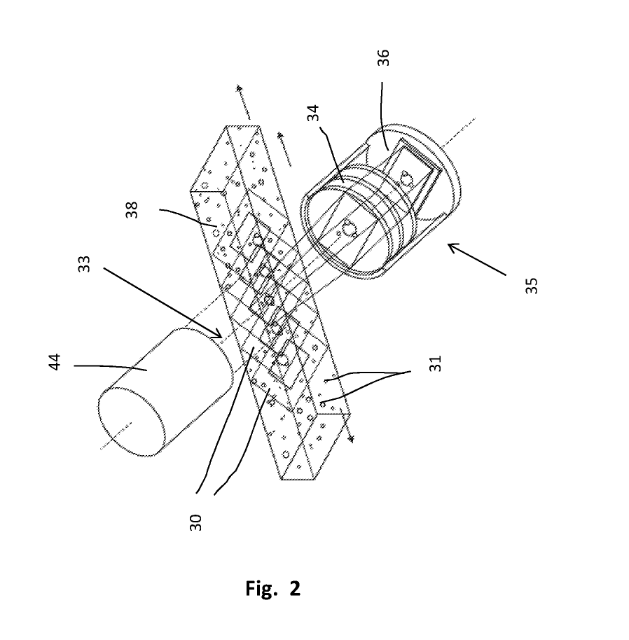

The optical system shown in FIG. 2 is similar to the optical system of FIG. 1 and comprises an optical detection assembly 35 and an illuminating device 44. The optical detection assembly 35 and the illuminating device 44 are preferably arranged such that they have the same center axis, namely the optical axis 33.

The optical detection assembly 35 comprises a camera 36 and a lens system 44 for focusing light to the camera 36. Between the optical detection assembly 35 and the illuminating device 44, the optical system comprises a sample container 38 which in the shown embodiment contains a sample with a plurality of objects 31.

The optical system further comprises a not shown translation arrangement arranged to translate the optical detection assembly 35 and the sample container 38 with respect to each other e.g. as indicated by the arrows. The optical detection assembly 35 and the sample container 38 are arranged such that a plurality of image acquiring positions of the image acquisition area is generated along a scanning path in the sample container 38.

The optical system further comprises a not shown image analyzing processing system programmed as described above.

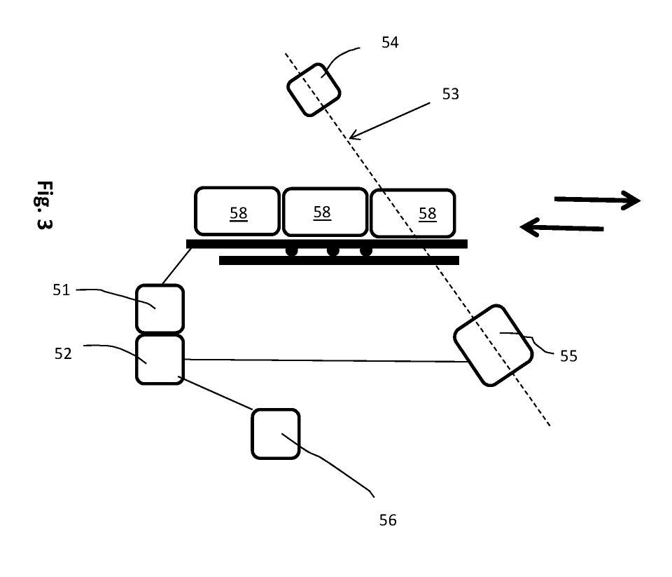

The optical system shown in FIG. 3 comprises an optical detection assembly 55 and an illuminating device 54. The optical detection assembly 55 and the illuminating device 54 are preferably arranged such that they have the same center axis, namely the optical axis.

The optical system further comprises a plurality of sample containers 58 arranged between the optical detection assembly 55 and the illuminating device 54. The optical system further comprises a translation arrangement 57 arranged to translate the optical detection assembly 55 and the sample containers 58 with respect to each other e.g. moving the sample containers as indicated by the arrows. The optical detection assembly 55 and the sample containers 58 are arranged such that a plurality of image acquiring positions of the image acquisition area is generated along the scanning paths in the respective sample containers 38.

The translation arrangement 57 is connected to a translation controller 51 programmed to control the translation of the translation arrangement 57

The optical system further comprises an image analyzing processing system 52 programmed to determine a set of features in the form of a set of values for each of a plurality of objects captured on said images from each respective scan and to determine for each scan at least one derived result, the derived result is derived from a plurality of the sets of values, and to transmit the derived result obtained from the respective, consecutive scans as a function of time to a presentation unit 56, such as a screen or a printer.

The translation controller 51 is preferably integrated with the image analyzing processing system 52 which is also programmed to perform consecutive scans through at least one part of said sample container, wherein each scan comprises acquiring images at a plurality of image acquiring positions of the image acquisition area by the optical detection assembly along at least one scanning path in the respective sample containers 58.

### EXAMPLES

### Example 1

### Monitoring of Brewing of Beer

Brewing of a beer comprises a number of steps including a fermentation step. The fermentation in brewing is the conversion of carbohydrates to alcohols and carbon dioxide or organic acids using yeasts, bacteria, or a combination thereof, under anaerobic conditions.

The fermentation is performed in a large tank. An optical system as described above is mounted on the tank, such that a sample from the tank can be drawn continuously the sample container of the optical system.

The wort and optionally other ingredients to be fermented are added to the tank. An amount of yeast is added and the fermentation process is started.

As the fermentation is started continuously samples is passed from the tank to pass in steps with a low velocity e.g. 5 ml/min through the sample container. At positions of acquiring samples the flow of the sample is temporally stopped such that the sample is at substantially standstill during the acquiring. The sample stream is returned to the tank.

The optical system is programmed to determine the concentration of living and active yeast cells as well as the relationship between living and dead yeast cells. A feed bag regulation to a supply arrangement for adding sugar and phosphoric acid (H3PO4) is provided. By adding sugar and phosphoric acid (H3PO4) the proliferation and survival of the yeast cells can be regulated and thereby the desired alcohol content can be obtained. Other ingredients can also be added by the feedback arrangement.

It is assumed that the sample is representative of the whole volume in the tank.

The optical system performs consecutive scans through the sample stream in the sample container, wherein each scan comprising translating the image acquisition area along at least one scanning path through the sample stream and acquiring images at a plurality of image acquiring positions of the image acquisition area. The images are analyzed in the image analyzing processing system of the optical system and comprises determining a set of features in the form of a set of values for each of a plurality of objects captured on the images from each respective scan and determining for each scan at least one derived result, where the derived result is derived from a plurality of the sets of values. The set of features is selected such that it reflects at least one of the characteristics a) the concentration of living and active yeast cells or b) the relationship between living and dead yeast cells. The derived result obtained from the consecutive scans as a function of time is presented in form of the feed bag arrangement and by showing on a monitor to follow the development of the fermentation process.

### Example 2

### Monitoring of Brewing of Beer

The fermentation is performed as in example 1 with the difference that the optical system additionally is programmed to monitoring a selected ratio (fingerprint) between certain selected substances in the liquid in the tank as the fermentations develops to reach a selected taste and texture for termination of the fermentation. The optical system determines one or more characteristics for the fingerprint as a function of time. When the fingerprint is reached the fermentation process is terminated.

### Example 3

### Monitoring of Purity of Water

Water from a lake or a stream or similar water reservoirs is usually not completely clean, but comprises a lot of different particles including microorganism. Often the purity is substantially stable, but it may happen that suddenly it changes e.g. due to pollution, for example due to a discharge of fertilizer or other chemicals. By monitoring the water such pollution will be discovered very fast and optionally an alarm can be triggered.

The monitoring will be realized by taking a “base-line” of the water reservoir in question. The base line is a fingerprint provided by a plurality of characteristics for the water when the water is in a condition considered as its standard condition. The fingerprint is obtained by determining a number of characteristics for a number of samples of the water reservoir in standard condition and for a number of samples of the water reservoir in polluted condition e.g. obtained by adding potential polluting elements to samples of the standard condition.

When the fingerprint of the water has been found an optical system is programmed to determine the plurality of characteristics for samples which are taken from the water reservoir in consecutively steps or alternatively of a continuous water sample stream from the water reservoir. If a change in the fingerprint is observed the alarm can be set to go off.

### Example 4

### Monitoring Growth of Yeast

A liquid sample containing yeast cells was monitored over a period of 30 hours using an optical system as shown in FIG. 2. The liquid sample was added into the sample container 38 and the optical system was programmed to perform consecutive scans through the sample container 38, wherein each scan comprised acquiring images of the image acquisition area by the optical detection assembly at a plurality of positions of the image acquisition area as it was translated along at least one scanning path of the scan. The image acquisition area was at a standstill relative to the sample container at the positions of the image acquisition area during image acquisition. Simultaneously the sample was at a substantially standstill.

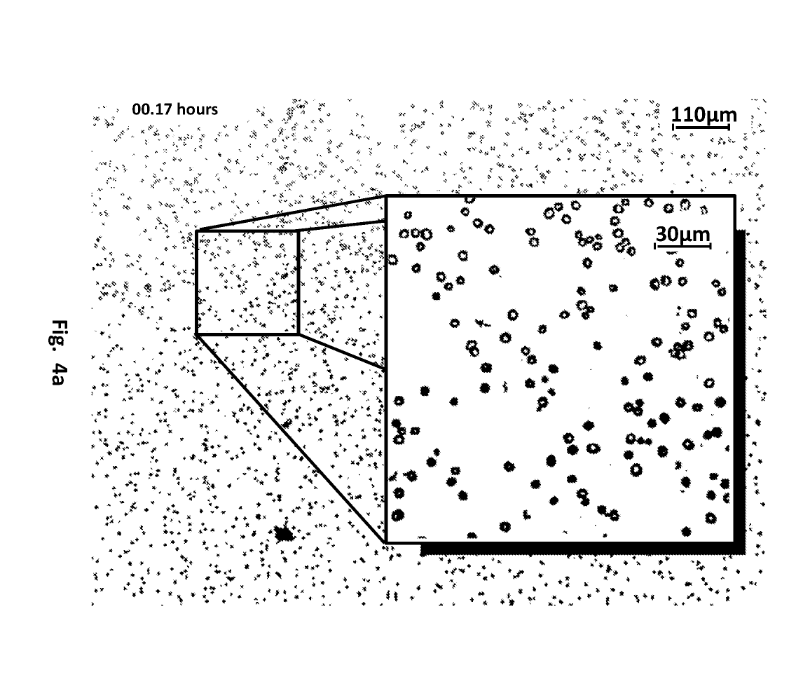

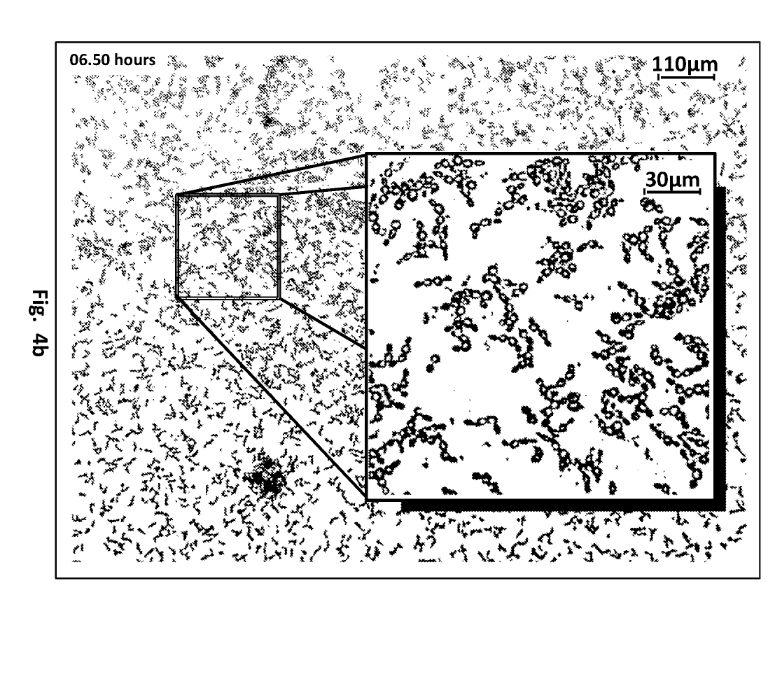

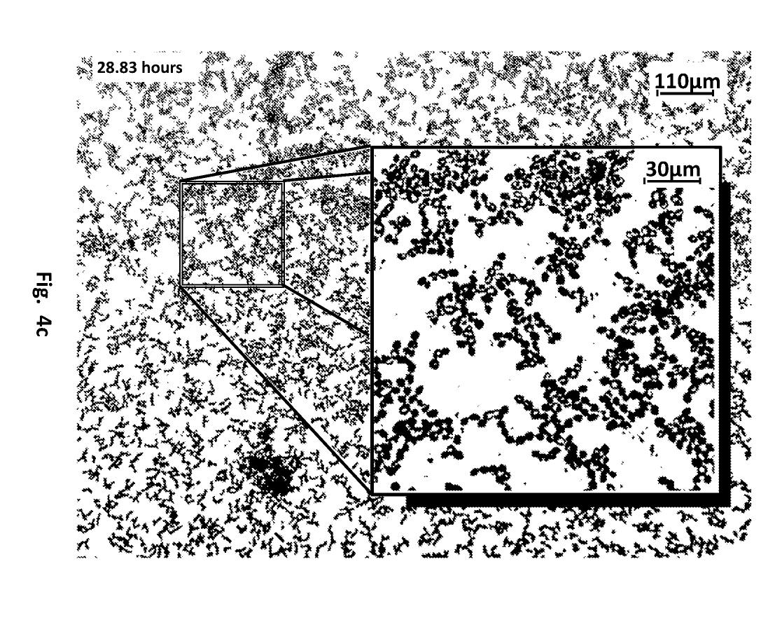

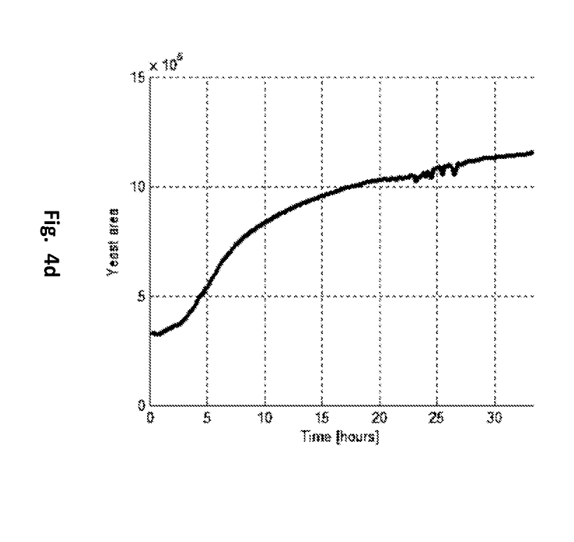

Every 10th minute an image scan of 40 images of the sample was acquired from a scan along a scanning path through the sample container. Each image scan was analyzed in the image analyzing processing system. For each image scan, 3D image segmentation was applied to separate the yeast cells in focus from background 3D image. The 3D image segmentation comprised removal of illumination profile, local thresholding and morphological area filtering (removal of unusually large and small objects). A focus function was applied to make sure only to include yeast cells perfectly in focus. Then the area of the each yeast cell was extracted, and the total yeast cell area was calculated. This process was repeated for all the image scans over the time period of the 30 hours, and finally the total yeast cell area was plotted as a function of time as shown in FIG. 4d.

FIGS. 4a, 4b and 4c show the yeast sample at three different points in time.

Only one of the 40 images is displayed from each scan. In each of the FIGS. 4a, 4b, 4c a smaller part of the image is displayed in an enlarged version.

FIG. 4a shows an image from the scan at 0.17 hours from start.

FIG. 4b shows an image from the scan at 6.50 hours from start.

FIG. 4c shows an image from the scan at 28.83 hours from start.

From the images shown in FIGS. 4a, 4b and 4c it can be seen that it is difficult to observe significant changes of growth at a short time scale and it is clear that many hours of scanning is required to visually determine significant changes of growth.

FIG. 4 shows the yeast cell area as a function of time. The curve of FIG. 4d gives a very detailed insight into how the yeast cells were developing during the 30 hours. For example it can easily be determined and for example it can be seen that the growth curve has a lag phase, a log phase and a deceleration phase.

Further from the curve it can also be seen that significant changes can be observed within few hours.

### Example 5

### Monitoring of Growth of Acidophilus Bacteria

A liquid sample containing acidophilus bacteria was monitored over a period of 20 hours using an optical system as shown in FIG. 2. The liquid sample was added into the sample container 38 and the optical system was programmed to perform consecutive scans through the sample container 38, wherein each scan comprises acquiring images of the image acquisition area by the optical detection assembly at a plurality of positions of the image acquisition area as it was translated along at least one scanning path of the scan. The image acquisition area was at a standstill relative to the sample container at the positions of the image acquisition area during image acquisition. Simultaneously the sample was at a substantially standstill.

Every 5th minute an image scan of 20 images was acquired in the sample from a scan along a scanning path through the sample container. Each image scan was analyzed in the image analyzing processing system. For each image scan a 3D segmentation method was to enable detection of the bacteria in focus in the sample. A focus function was applied to each object to ensure that only perfectly focused objects are included in the analysis.

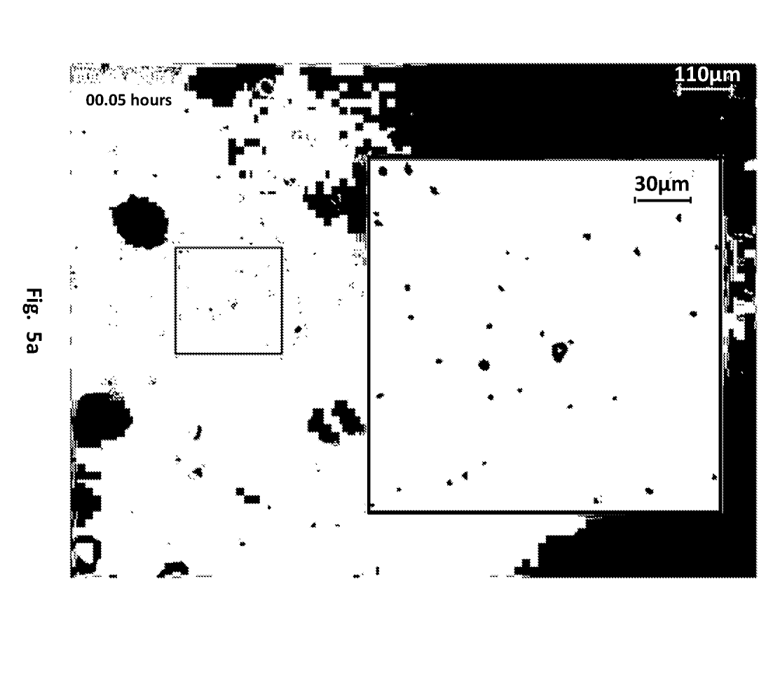

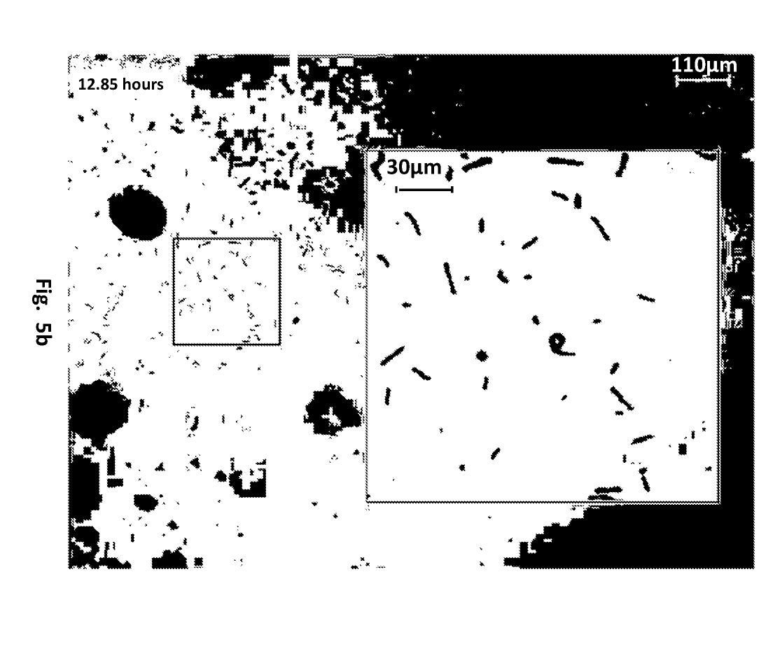

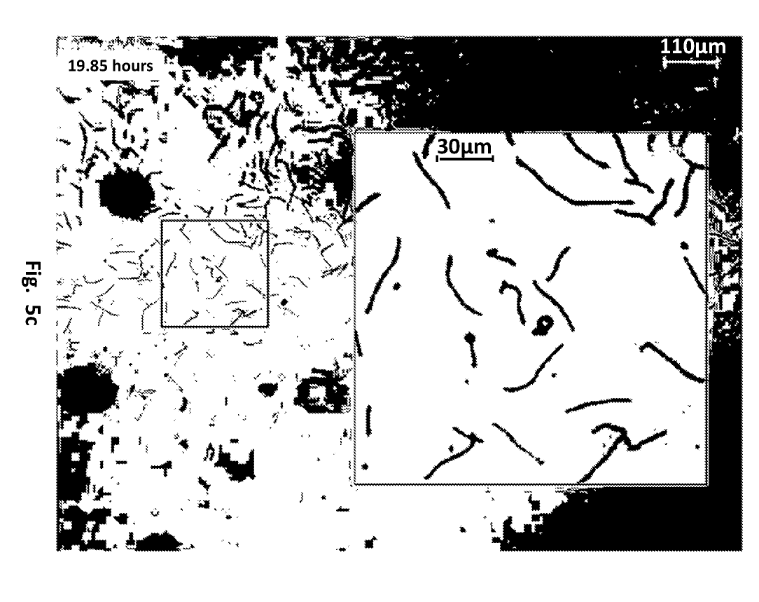

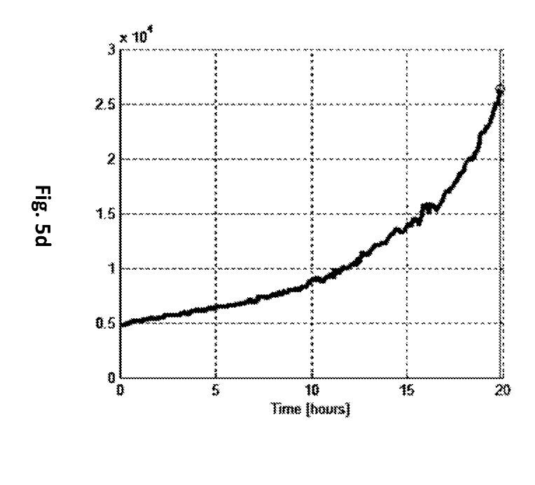

For each focused object an individual threshold was applied, separating the bacteria from the background. The length of the bacteria was extracted from its morphological skeleton and stored. The mean length of all bacteria in the sample was then calculated for each image scan. When all time lapses were processed, a curve showing the mean length as a function of time was constructed and is shown in FIG. 5d.

FIGS. 5a, 5b and 5c show the acidophilus bacteria sample at three different points in time.

Only one of the 20 images is displayed from each scan. In each of the FIGS. 5a, 5b, 5c a smaller part of the image is displayed in an enlarged version to enhance visibility.

FIG. 5a shows an image from the scan at 0.06 hours from start.

FIG. 5b shows an image from the scan at 12.85 hours from start.

FIG. 5c shows an image from the scan at 19.85 hours from start.

From the images shown in FIGS. 5a, 5b and 5 it can be seen that it is difficult to observe significant changes of growth at a short time scale and it is clear that many hours of scanning is required to visually determine significant changes of growth.

FIG. 5d shows the acidophilus bacteria length as a function of time and the curve gives a very detailed insight into how the yeast cells were developing during the 20 hours. Further it can also be seen from the curve that significantly changes can be observed within few hours which means that a very fast susceptibility test can be performed using the optical system and the method of the invention.

1. An optical system for determining a characteristic as a function of time of at least a part of a liquid volume comprising a plurality of objects, the optical system comprises:
an optical detection assembly comprising at least one image acquisition device configured to acquire images of an image acquisition area;
a sample device comprising at least one sample container suitable for holding a sample of said liquid volume;
a translating arrangement configured to translate said image acquisition area through at least one part of said sample container to perform a scan along a scanning path through said part of said sample container; and
an image analyzing processing system,
wherein said optical system is programmed to perform consecutive scans through said at least one part of said sample container, wherein each scan comprises acquiring images of said image acquisition area by the optical detection assembly at a plurality of positions of the image acquisition area as it is translated along at least one scanning path of the scan; and said image analyzing processing system is programmed to determine a set of features in the form of a set of values for each of a plurality of objects captured on said images from each respective scan and to determine for each scan at least one derived result, the derived result is derived from a plurality of the sets of values, and to present said derived result obtained from the respective, consecutive scans as a function of time.
characterized in that the sample container is constructed to hold a sample at a substantially standstill during a scan.

2. The optical system of claim 1 wherein the optical system is configured to acquire said images of said image acquisition area at said plurality of positions, wherein said image acquisition area is at a standstill relative to the sample container.

3. (canceled)

4. The optical system of claim 1, wherein the optical system is configured to acquire said images of said image acquisition area at said plurality of positions, wherein a sample in the sample container at a substantially standstill.

5. The optical system of claim 1 wherein the object is a particle or a cluster of particles, the particles are selected from non-biologic particles, such as particles of metal, particles of polymer, crystals, drops of fat and mixtures thereof and/or the particles are selected from biologic particles, such as particles of bacteria, archaea, yeast, fungi, pollen, viruses, leukocytes, such as granulocytes, monocytes, Erythrocytes, Thrombocytes, oocytes, sperm, zygote, stem cells, somatic cells, malignant cells and mixtures thereof.

6. The optical system of claim 5 wherein the particles comprise pathogens, such as pathogens selected from viral pathogens, bacterial pathogens, parasites, fungan pathogens, prionic pathogens and combinations thereof.

7. The optical system of claim 1 wherein the characteristic(s) comprises one or more of a geometric characteristic, such as size or shape; a light interaction characteristic, such as contrast, light scattering properties, absorption, transparency, number of particles in a cluster, distance between particles in a cluster, distance between clusters, formation or re-formation of particles or clusters of particles or homogeneity/inhomogeneity of the sample.

8. (canceled)

9. (canceled)

10. (canceled)

11. The optical system of claim 1 wherein the optical system is programmed to set the time offset between scans about to be performed depending on the derived result obtained from one or more previously performed scans, preferably such that the time offset between scans about to be performed is relatively long if the derived result from two or more previously performed scans are substantially identical and such that the time offset between scans about to be performed is relatively short if the derived result from two or more previously performed scans are different from each other.

12. The optical system of claim 1 wherein said image analyzing processing system is programmed to determine sets of values for a predetermined set of features comprising at least N features for each of said complete stacks of objects, wherein N is 1 or more, such as 2 or more, such as 3 or more, such as 4 or more, such as up to about 1 00.

13. The optical system of claim 1 wherein said optical system is arranged such that the sample in the sample container can be subjected to an external exposure during the consecutive scans, the external exposure is for example heat, cooling, irradiation, magnetic exposure, electrical exposure, pressure, centrifugal forces, vibrations or other mechanical forces such as forcing the sample through a constriction to generate a venture effect.

14. (canceled)

15. (canceled)

16. The optical system of claim 1 wherein said optical system is configured to determine one or more characteristics as a function of time of at least two samples simultaneously, the system is preferably programmed to continue performing consecutive scans until the derived result for one of the samples differs significantly from the derived result for another one of the samples.

17. (canceled)

18. An optical system of claim 1 for determining and adjusting a characteristic as a function of time of at least a part of the liquid volume comprising a plurality of objects, the optical system further comprises a feedback configuration arranged to subject the sample and/or the liquid volume to an influence in response to a determined characteristic, the influence is preferably in the form of one or more external exposures, such as heat, cooling, irradiation, magnetic exposure, electrical exposure, pressure, centrifugal forces, vibrations or other mechanical forces and/or in the form of adding one or more substances, such as nutrient, agents, diluting liquid, ph regulator or tensides and/or in the form of removing one or more substances, such as liquid via a filter.

19. An optical system of claim 11, wherein the optical system is programmed to adjust the characteristic according to a pre-selected pattern, which pre-selected pattern can be a stationary pattern or a pattern that changes as a function of time.

20. (canceled)

21. (canceled)

22. (canceled)

23. (canceled)

24. (canceled)

25. A method of determining a characteristic as a function of time of a liquid volume comprising a plurality of objects, the method comprises performing consecutive scans through at least one part of a liquid sample of said liquid volume using at least one image acquisition device configured to acquire images of an image acquisition area, wherein each scan comprises translating said image acquisition area along at least one scanning path through said at least one part of said sample and acquiring images at a plurality of image acquiring positions of the image acquisition area, and determining a set of features in the form of a set of values for each of a plurality of objects captured on said images from each respective scan and determining for each scan at least one derived result, the derived result is
derived from a plurality of the sets of values, and presenting said derived result obtained from the consecutive scans as a function of time,
characterized in that the method comprises holding the sample at a substantially standstill during the scan.

26. The method of claim 25, wherein the method comprises providing that said image acquisition area is at a standstill relative to the sample container when acquiring said respective images of said image acquisition area at said plurality of positions.

27. (canceled)

28. (canceled)

29. The method of claim 25, wherein the method comprises continuously performing the consecutive scans for a predetermined time or until the characteristic has reached a selected change in the form of a selected difference between the derived result from a first scan to a last scan of the consecutive scans.

30. (canceled)

31. (canceled)

32. (canceled)

33. (canceled)

34. (canceled)

35. (canceled)
